(19) United States
(12) Patent Application Publication
(10) Pub. No.: US 2019/0182141 A1
(43) Pub. Date: Jun. 13, 2019

(54) HIGH-SPEED NETWORK APPARATUS AND SELF-TESTING METHOD THEREOF

(71) Applicant: NEXCOM International Co., Ltd., New Taipei City (TW)

(72) Inventor: Chun-Pin SHIH, New Taipei City (TW)

(21) Appl. No.: 15/913,975

(22) Filed: Mar. 7, 2018

(30) Foreign Application Priority Data
Dec. 13, 2017 (TW) 106143800

(51) Int. Cl. H04L 12/26

(52) U.S. Cl. CPC H04L 43/50; H04L 43/0888; H04L 43/0894; H04L 43/0829

(57) ABSTRACT

A high-speed network apparatus and a self-testing method thereof are provided. The method is to configure a first network interface to transmit a plurality of test Ethernet frames to a second network interface via a network cable continuously during a default time interval, count a number of the transmitted test Ethernet frames, compare the counted number with a default value, and issue a notification according to a result of comparison. The present disclosed example can test a transmission speed of a high-speed network apparatus effectively without any additional test apparatus, and can reduce a cost of test significantly.

### BACKGROUND OF THE INVENTION

### Field of the Invention

The technical field relates to apparatus and method, and more particularly related to high-speed network apparatus and self-testing method thereof.

### Description of Related Art

The high-speed Ethernet technology has ability of supplying a transmission speed which is faster than 1 gigabits per second (1 Gbps). Moreover, many high-speed network apparatuses suppling the high-speed Ethernet technology had been provided on the market currently.

In general, the network apparatus must be tested before leaving the factory for making sure that a transmission performance the network apparatus conforms to the corresponding specifications (such as the maximum transmission speed is not less than 100 Mbps).

Please refer to FIG. 1, which is a schematic view of test of a network apparatus of the related art. As shown in figure, a testing method of the related art is configured to test the manufactured network apparatuses 10, 12 by a special Ethernet test apparatus 14.

More specifically, the tester first makes two network connection ports of the Ethernet test apparatus 14 respectively connect to two network connection ports of the network apparatus 10 by two network cables 160,162, and make the other two network connection ports of the Ethernet test apparatus 14 respectively connect to two network connection ports of another network apparatus 12 by two network cables 164,166. Then, the tester may operate the Ethernet test apparatus 14 to generate a lot of simulation packets, and transmit the simulation packets to the network apparatuses 10, 12 for testing their transmission speeds.

Although above-mentioned 14 may test the transmission speed of the network apparatus 10, 12 effectively, most of the network apparatuses provided on the market currently only have ability of testing the transmission speed for the general transmission level (such as 1 Gbps) because of the scant hardware performance, and do not have ability of testing the transmission speed for the high-speed Ethernet level (such as 10 Gbps).

Besides, a high-speed Ethernet test apparatus having strengthened hardware performance had been provided currently. Although above-mentioned high-speed Ethernet test apparatus has ability of testing transmission speed for high-speed transmission level (such as 10/100 Gbps), above-mentioned high-speed Ethernet test apparatus usually applies to experiment in a research and development stage caused by the high-speed Ethernet test apparatus being very expensive. Because the manufacturers do not have enough funds for buying the very expensive high-speed Ethernet test apparatus usually, the manufacturers do not have ability of testing the transmission speed of the manufactured high-speed network apparatus, and do not have ability of ensuring that the manufactured high-speed network apparatus meets a transmission level of its specification.

Accordingly, there is currently a need for a method of testing a high-speed network apparatus having ability of testing the transmission speed of the high-speed network apparatus in a low-cost way efficiently.

### SUMMARY OF THE INVENTION

The present disclosed example is directed to a high-speed network apparatus and self-testing method thereof, the present disclosed example has ability of testing a transmission speed of the high-speed network apparatus via the hardware of the high-speed network apparatus without any additional test apparatus.

One of the exemplary embodiments, a self-testing method for testing transmission performance of a high-speed network apparatus comprising a first network interface and a second network interface, comprises following steps of: a) configuring the first network interface to start to transmit a plurality of test Ethernet frames to the second network interface via a network cable; b) count a number of the test Ethernet frames had been transmitted; c) configuring the first network interface to stop transmitting the test Ethernet frames if a default time interval elapses; d) issuing a notification of pass in speed test if the number of the test Ethernet frames had been transmitted is not less than a default value; and, e) issuing a notification of fail in speed test if the number of the test Ethernet frames had been transmitted is less than the default value.

One of the exemplary embodiments, a high-speed network apparatus having ability of testing transmission performance itself, comprises a first network interface, a second network interface, a human-machine interface and a processor electrically connected to the first network interface, the second network interface and the human-machine interface. The first network interface is connected to one end of a network cable and transmits a plurality of test Ethernet frames to the network cable. The second network interface is connected to another end of the network cable and receives the test Ethernet frames from the network cable. The human-machine interface is configured to issue notification. The processor comprises a timing module, a transmission control module, a count control module and a notification module. The timing module is configured to start to time a default time interval after the first network interface starts to transmit the test Ethernet frames. The transmission control module is configured to configure the first network interface to start to transmit the test Ethernet frames, and configure the first network interface to stop transmitting the test Ethernet frames after the default time interval elapses. The count control module is configured to retrieve a number test Ethernet frames had been transmitted. The notification module is configured to control the human-machine interface to issue a notification of pass in speed test if the number of the test Ethernet frames had been transmitted is not less than a default value, and issue a notification of fail in speed test if the number of the test Ethernet frames had been transmitted is less than the default value.

The present disclosed example can test a transmission speed of a high-speed network apparatus effectively without any additional test apparatus, and can reduce a cost of test significantly.

### BRIEF DESCRIPTION OF DRAWING

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is a schematic view of test of a network apparatus of the related art;

FIG. 2 is an architecture diagram of a high-speed network apparatus according to a first embodiment of the present disclosed example;

FIG. 3 is an architecture diagram of a high-speed network apparatus according to a second embodiment of the present disclosed example;

FIG. 4 is a schematic view of connection of a high-speed network apparatus according to a third embodiment of the present disclosed example;

FIG. 5 is a schematic view of network interface according to a fourth embodiment of the present disclosed example;

FIG. 6 is an architecture diagram of a processor according to a fifth embodiment of the present disclosed example;

FIG. 7 is a flowchart of a self-testing method according to the first embodiment of the present disclosed example;

FIG. 8 is a partial flowchart of a self-testing method according to the second embodiment of the present disclosed example;

FIG. 9 is a partial flowchart of a self-testing method according to the second embodiment of the present disclosed example; and

FIG. 10 is a partial flowchart of a self-testing method according to the fourth embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

The present disclosed example mainly provides a self-testing technology applied to the high-speed network apparatuses shown in FIG. 2 to FIG. 6. Above-mentioned self-testing technology mainly executes high-speed transmission and high-speed reception of Ethernet frames by its own hardware, so as to test the transmission speed of the high-speed network apparatus.

Please refer to FIG. 2, which is an architecture diagram of a high-speed network apparatus according to a first embodiment of the present disclosed example. In this embodiment, the high-speed network apparatus 2 may be a computer having ability of connecting to a network. More specifically, the high-speed network apparatus 2 may comprise a first network interface 21, a second network interface 22, a storage module 23, a human-machine interface 24, and a processor 20 electrically connected to above devices.

The first network interface 21 and the second network interface 22 may be the same or similar type of network interface, and have ability of executing Ethernet transmission. One of the exemplary embodiments, the first network interface 21 and the second network interface 22 may be the high-speed network interface card (high-speed NIC) supplying 1 Gbps or faster transmission level.

One of the exemplary embodiments, if the maximum transmission level supplied by the first network interface 21 is same as the maximum transmission level (such as 100 Gbps) supplied by the second network interface 22, the present disclosed example can test above maximum transmission level (such as 100 Gbps).

One of the exemplary embodiments, if the maximum transmission level (such as 10 Gbps) supplied by the first network interface 21 is different from the maximum transmission level (such as 100 Gbps) supplied by the second network interface 22, the present disclosed example can test the lower transmission level (such as 10 Gbps) of the two.

The storage module 23, such as cache memory, RAM, compact disc, flash memory, hard disk or any combination of above storage modules, is used to store data. The human-machine interface 24, such as keyboard, mouse, display, touch screen, speaker and/or the other input/output devices, is used to receive use operations and/or output information, such as a notification of pass in speed test, a notification of fail in speed test and a notification of connection defect described later. The processor 20 is used to control each of the devices of the high-speed network apparatus 2.

One of the exemplary embodiments, the storage module 23 comprises non-transitory computer-readable media storing an operating system 230 and an application program 231, both of the operating system 230 and the application program 231 record computer-readable codes. The processor 20 may execute the operating system 230, and execute the application program 230 during run time of the operating system 231 for interacting with the first network interface 21 and the second network interface 22 for implementing the self-testing method of each of the embodiments of the present disclosed example.

Please be noted that the tester must make one end of a network cable (such as optical fiber cable, twisted pair or biaxial copper cable) connect to the first network interface 21, and another end of the network cable connect to the second network interface 22, so as to make the first network interface 21 and the second network interface 22 to form a physical loopback and transmit signals each other in the physical loopback.

Please be noted that, because a virtual loopback of the related art constituted by a physical network interface and a virtual network interface operates in the TCP/IP Layer of interconnection model, the virtual loopback of the related art must consume a large amount of processor resources for simulating the virtual network interface and encapsulation/decapsulation of packets. Above-mentioned status makes a transmission speed of the virtual loopback of the related art is unable to reach the transmission level of high-speed Ethernet (such as 1 Gbps), and is unable to be used to test the transmission speed of the high-speed network apparatus.

The present disclosed example can make the transmission speed of the Ethernet frames reach the high-speed Ethernet transmission level (described later) effectively via implementing the physical loopback via the two physical high-speed network interfaces, and making the physical high-speed network interfaces transmit/receive Ethernet frames in the Data Link Layer and the Physical Layer.

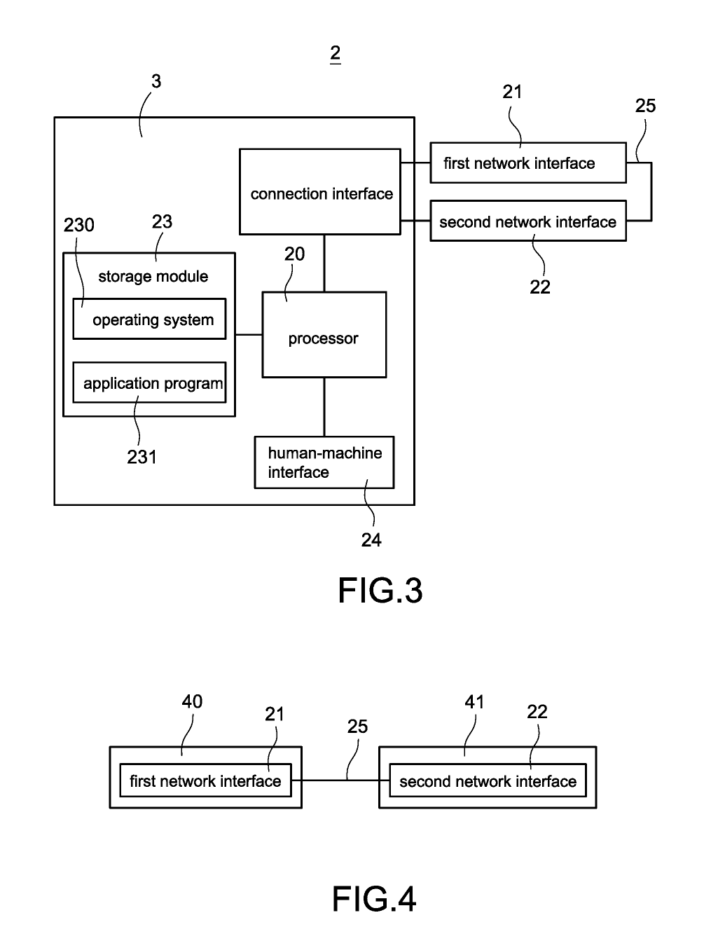

Please refer to FIG. 3, which is an architecture diagram of a high-speed network apparatus according to a second embodiment of the present disclosed example. In this embodiment, the high-speed network apparatus 2 comprises a first network interface 21, a second network interface 22 and a computer host 3 which are arranged independently. The computer host 3 comprises a processor 20, a storage module 23, a human-machine interface 24, and a connection interface 30 (such as PCI Express interface or the other interfaces supplying high-speed transmission).

The first network interface 21 and the second network interface 22 may form an electrical connection with the processor 20 via a connection interface 30, so as to be controlled by the processor 20 and make the computer host 3 have ability of connecting network.

Please be noted that, in this embodiment, the tester must make both the first network interface 21 and the second network interface 22 removably connect to the connection interface 30 of the computer host 3, and make both ends of the network cable 25 respectively connect to the first network interface 21 and the second network interface 22 for forming the physical loopback for execution of the self-testing method described later.

Please refer to FIG. 4, which is a schematic view of connection of a high-speed network apparatus according to a third embodiment of the present disclosed example. Compare to above-mentioned high-speed network apparatus 2, each of the high-speed network apparatuses 40, 41 of this embodiment only comprises one network interface. For example, the first network interface 21 is arranged on the high-speed network apparatus 40, and the second network interface 22 is arranged on the high-speed network apparatus 41.

In this embodiment, the tester is to make both ends of the network cable 25 respectively connect to the first network interface 21 of the high-speed network apparatus 40 and the second network interface 22 of the high-speed network apparatus 41 for forming the physical loopback for execution of the self-testing method described later.

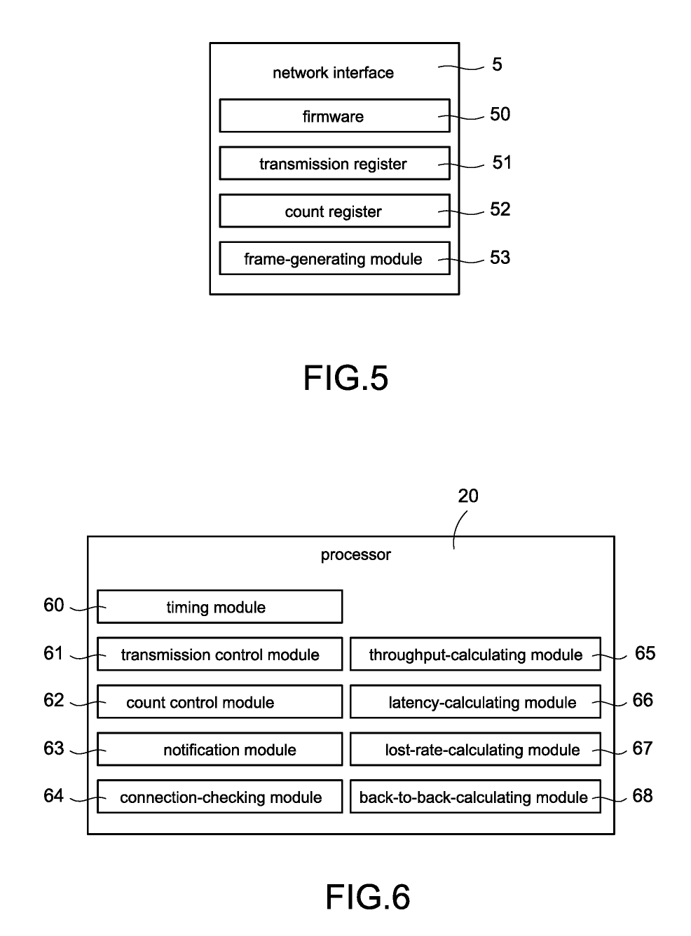

Please refer to FIG. 5, which is a schematic view of network interface according to a fourth embodiment of the present disclosed example. In this embodiment, the network interface 5 (such as above-mentioned first network interface 21 or second network interface 22) may comprise a firmware 50, a transmission register 51, a count register 52, and a frame-generating module 53.

The firmware 50 is stored in a storage module (not shown in figure) of the network interface 5, the firmware 50 is configured to aid the processor 20 to control and configured the network interface 5. The transmission register 51, the count register 52 and the frame-generating module 53 may be arranged in a micro-controller (not shown in figure) of the network interface 5, and is configured to execute the self-testing method described later.

More specifically, the transmission register 51 is configured to control the network interface 5 to start to transmit the test Ethernet frames or stop transmitting the test Ethernet frames. The count register 52 is configured to count a number of the test Ethernet frames transmitted from the network interface 5 or received by the network interface 5. The frame-generating module 53 is configured to generate the test Ethernet frames.

Please refer to FIG. 6, which is an architecture diagram of a processor according to a fifth embodiment of the present disclosed example. More specifically, the processor 20 may interact with the first network interface 21 and the second network interface 22 via execution of application program 231 for implementing each of functions of the self-testing method of the present disclosed example. Moreover, the application program 231 comprises a plurality of groups of computer-executable codes respectively corresponding to following function module, the processor 20 may implement following function module via execution of the groups of computer-executable codes.

1. Timing module 60 is configured to time a default time interval (such as 30 seconds), and trigger a time-up signal after the default time elapses.

2. Transmission control module 61 is configured to configure the network interface 5 to start to transmit the Ethernet frames or stop transmitting the Ethernet frames. One of the exemplary embodiments, the transmission control module 61 may enable the transmission register 51 via execution of the firmware 50 (such as configuring a value of the transmission register 51 as 1) for making the network interface 5 start to transmit the Ethernet frames, or disable the transmission register 51 via execution of the firmware 50 (such as configuring a value of the transmission register 51 as 0) for making the network interface 5 stop transmitting the Ethernet frames.

3. Count control module 62 is configured to retrieve a number of the Ethernet frames transmitted or received during above-mentioned default time interval by the network interface 5. One of the exemplary embodiments, the count control module 62 may enable the count register 52 via execution of firmware 52 (such as configuring a value of the count register 52 as 0) for making the count register start to count the number of the Ethernet frame. Moreover, after time is up, the count control module 62 may read a reading of the control module 52 via execution of the firmware 50 for retrieving the final number of the Ethernet frame had been transmitted or received.

4. Notification module 63 is configured to generate a notification and control the human-machine interface 24 to output the generated notification.

5. Connection-checking module 64 is configured to check whether a connection (such as the network cable 25) between the two connected network interfaces 5 (such as first network interface 21 and second network interface 22) works normally.

6. Throughput-calculating module 65 is configured to calculate a throughput of transmission between the two network interfaces 5.

7. Latency-calculating module 66 is configured to calculate a latency of transmission between the two connected network interfaces 5.

8. Lost-rate-calculating module 67 is configured to calculate a lost rate of transmission between the two connected network interfaces 5.

9. Back-to-back-calculating module 68 is configured to calculate a back-to-back value of transmission used to indicate a buffering capability between the two connected network interfaces 5.

Thus, the present disclosed example can test the transmission performance of the two connected network interfaces 5 (such as the first network interface 21 and the second network interface 22).

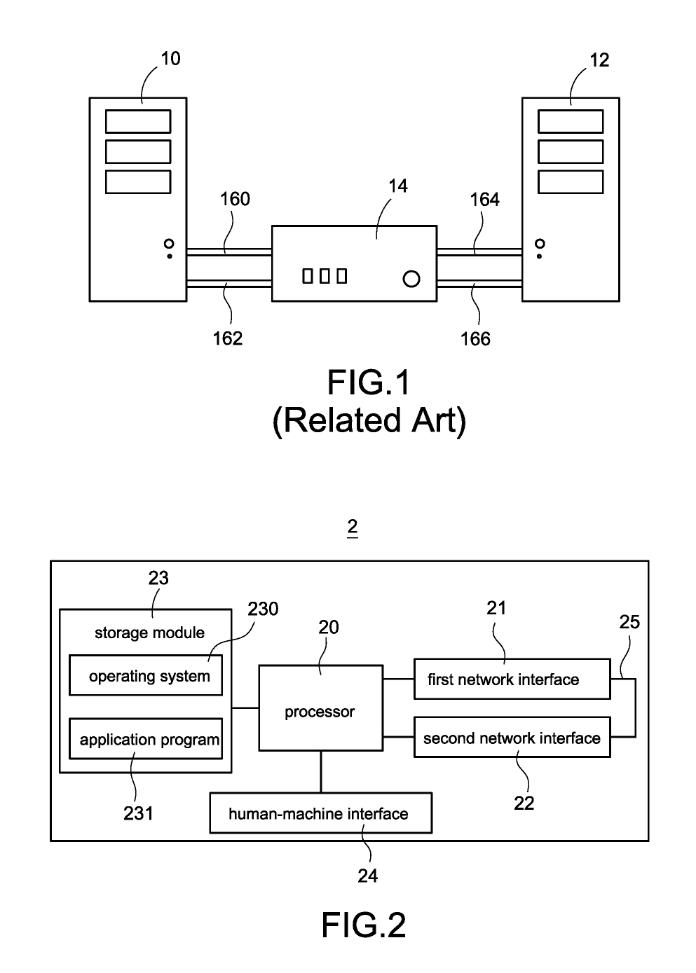

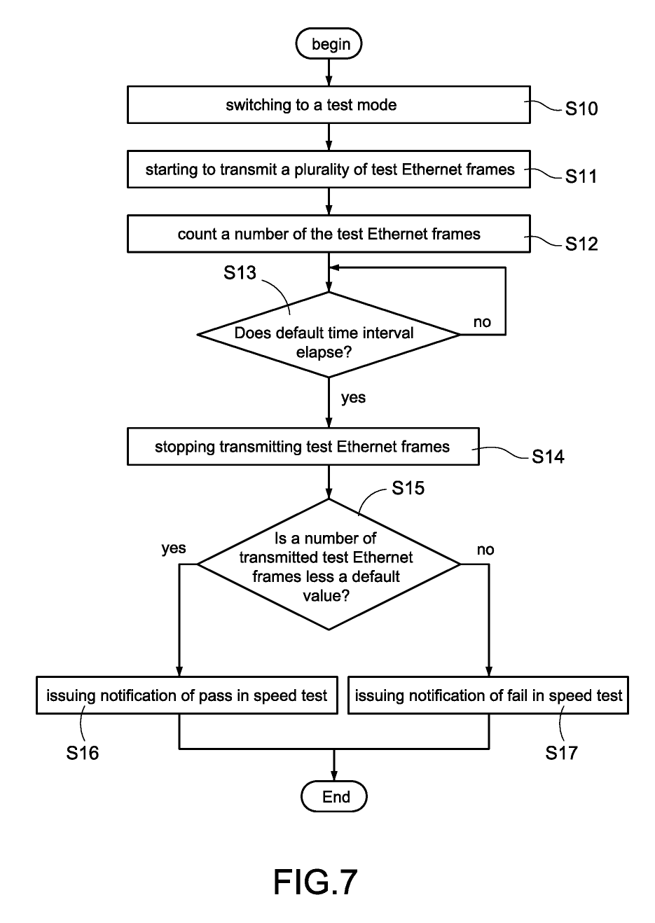

Please refer to FIG. 7 is a flowchart of a self-testing method according to the first embodiment of the present disclosed example. The self-testing method of each of the embodiments of the present disclosed example may be implemented by the high-speed network apparatus shown in FIG. 1 to FIG. 6. Following description takes the high-speed network apparatus 2 shown in FIG. 2 for explanation. The self-testing method of this embodiment comprises following steps.

Step S10: the processor 20 controls the high-speed network apparatus 2 to switch to a test mode. One of the exemplary embodiments, the processor 20 configures the first network interface 21 and the second network interface 22 to switch to the test mode via the transmission control module 61.

One of the exemplary embodiments, after the first network interface 21 and the second network interface 22 switch to the test mode, the processor 20 may further initialize the count register 52 (hereinafter the first count register for abbreviation, the initialization may be configuring a first reading of the first count register as 0) of the first network interface 21 via the count control module 62. Moreover, the processor 20 may further initialize the count register 52 (hereinafter the second count register for abbreviation, the initialization may be configuring a second reading of the second count register as 0) of the second network interface 22 via the count control module 62.

Step S11: the processor 20 configures the first network interface 61 to start to transmit a plurality of test Ethernet frames via the transmission control module 61.

One of the exemplary embodiments, the processor 20 may first enable the frame-generating module 53 (hereinafter first frame-generating module for abbreviation) of the first network interface 21 via the transmission control module 61 for making the first frame-generating module start to generate a plurality of test Ethernet frames.

Then, the processor 20 may enable the transmission register 51 (hereinafter the first transmission register for abbreviation) of the first network interface 21 via the transmission control module 61, such as configuring a value of the first transmission register as 1, for making the first network interface 21 start to transmit a plurality of test Ethernet frames generated by the first frame-generating module to the second network interface 22 via the network cable 25.

One of the exemplary embodiments, the processor 20 may time the default time interval via the timing module 60 simultaneously.

Step S12: the processor 20 counts a number of the test Ethernet frames had been transmitted via the count control module 62.

One of the exemplary embodiments, the process 20 configures the first count register to start to count a number of the test Ethernet frame transmitted from the first network interface 21, or configures the second count register to start to count a number of the test Ethernet frame received by the first network interface 22.

Step S13: the processor 20 determines whether the default time interval elapses via the timing module 60.

One of the exemplary embodiments, the processor 20 determines that the default time interval elapses if detecting a time-up signal triggering by the timing module 60, and determines that the default time interval does not elapse if does not detecting the time-up signal.

If the default time interval had elapsed, the processor 20 performs the step S13 again for determining whether the default time interval elapses continuously. Otherwise, the processor 20 performs a step S14.

Please be noted that, during the perform the first network interface 21 transmits a plurality of test Ethernet frames to the second network interface 22 continuously, the first count register of the first network interface 21 or the second count register of the second network interface 22 count the number of the test Ethernet frames had been transmitted or received continuously.

Step S14: the processor 20 configures the first network interface 21 to stop transmitting the test Ethernet frames via the transmission control module 61.

One of the exemplary embodiments, the processor 20 disable the first transmission register via the transmission control module 61, such as configuring the value of the first transmission register as 0, for making the first network interface 21 stop transmitting any test Ethernet frame to the second network interface 22.

One of the exemplary embodiments, the processor 20 may further disable the first frame-generating module of the first network interface 21 for making the first frame-generating module stop generating the test Ethernet frames.

One of the exemplary embodiments, the processor 20 may further control the timing module 60 to stop timing simultaneously.

Step S15: the processor 20 retrieves the number of the test Ethernet frames had been transmitted during the default time interval via the count control module 62, and determines whether the number of the test Ethernet frames is not less than a default value (speed default value), wherein the default corresponds to the maximum transition level of the first network interface 21 or the second network interface 22.

One of the exemplary embodiments, the processor 20 may read a first reading from the first count register as the number of test Ethernet frames had been transmitted via the count control module 62, or read a second reading from the second count register as the number of test Ethernet frames had been received.

One of the exemplary embodiments, the processor 20 may configure an average of the first reading and the second reading as the number of the test Ethernet frames, or select one of the first reading and the second reading as the number of the test Ethernet frames. For example, if the first reading is different from the second reading, the processor 20 may select the less one of the first reading and the second reading as the number of the test Ethernet frames.

For example, if a size of each of the test Ethernet frames is 1518 bytes, the maximum transition level of the first network interface 21 and the second network interface 22 is 1 Gbps, the default value described in the step S15 may be 81275 or the other similar values (such as any value in a range of positive and negative 10% of 81275).

In another example, if the size of each of the test Ethernet frames is 1518 bytes, the maximum transition level of the first network interface 21 and the second network interface 22 is 10 Gbps, the default value described in the step S15 may be 812744 or the other similar values (such as any value in a range of positive and negative 10% of 812744).

If the processor 20 determines the number of the test Ethernet frames is not less than the default value, performs a step S16. Otherwise, the processor 20 performs the step S17.

Step S16: the processor 20 generates a notification of pass in speed test via the notification module 63, and outputs the generated notification of pass in speed test via the human-machine interface 24 for notifying the tester that an actual transmission speed of the first network interface 21 and the second network interface 22 is matched with their specifications.

Step S17: the processor 20 generates a notification of fail in speed test via the notification module 63, and outputs the generated notification of fail in speed test via the human-machine interface 24 for notifying the tester that the actual transmission speed of the first network interface 21 and the second network interface 22 is not matched with their specifications.

Please be noted that above-mentioned notification of pass in speed test and notification of fail in speed test may be text message, voice message, indicator light message, or the other types of messages, but this specific example is not intended to limit the scope of the present disclosed example.

The present disclosed example can test a transmission speed of a high-speed network apparatus effectively without any additional test apparatus, and can reduce a cost of test significantly.

Please be noted that although this embodiment takes it for example that a forward transmission test (the first network interface 21 is transmitting end, and the second network interface 22 is receiving end), but this specific example is not intended to limit the scope of the present disclosed example. One of the exemplary embodiments, a reverse transmission test (the second network interface 22 is transmitting end, and the first network interface 21 is receiving end) may be provided and used.

Please be noted that, although this embodiment takes one-way transmission test for example, but this specific example is not intended to limit the scope of the present disclosed example. One of the exemplary embodiments, bidirectional transmission test may be provided and used.

More specifically, the first network interface 21 may be the transmitting end and send the test Ethernet frames to the second network interface 22 via the network cable 25. Moreover, the first network interface 21 may be receiving end simultaneously, and receive the test Ethernet frames transmitted from the second network interface 22 via the network cable 25. In the same way, the second network interface 22 may be receiving end and receive the test Ethernet frames from the first network interface 21 via the network cable 25. Moreover, the second network interface 22 may be transmitting end simultaneously, and transmit the test Ethernet frames transmitted to the first network interface 21 via the network cable 25.

Furthermore, because each of the network interfaces may only comprise one count register, in this status, the second count register of the second network interface 22 must be configured to count the number of the test Ethernet frames transmitted by the second network interface 22 if the first count register of the first network interface 21 is configured to count the number of the test Ethernet frames transmitted by the first network interface 21. Moreover, the second count register of the second network interface 22 must be configured to count the number of the test Ethernet frames received by the second network interface 22 if the first count register of the first network interface 21 is configured to count the number of the test Ethernet frames received by the first network interface 21. Thus, each of the network interfaces according to this embodiment may implement the bidirectional transmission test via single count register.

One of the exemplary embodiments, there are two or more count registers arranged on each of the network interfaces. For example, the first network interface 21 may comprise a first transmission count register and a first reception count register, the second network interface 22 may comprise a second transmission count register and a second reception count register. During bidirectional transmission test, the first transmission count register of the first network interface 21 may count the number of the test Ethernet frames transmitted by the first network interface 21, and the first reception count register of the first network interface 21 may count the number of the test Ethernet frames received by the first network interface 21. Moreover, the second transmission count register of the second network interface 22 may count the number of the test Ethernet frames transmitted by the second network interface 22, and the second reception count register of the second network interface 22 may count the number of the test Ethernet frames received by the second network interface 22.

This embodiment can obtain the readings of each of the count registers of transmitting end and receiving end of each of the transmission directions effectively, and further determine whether any connection defect existed in any transmission direction (described later).

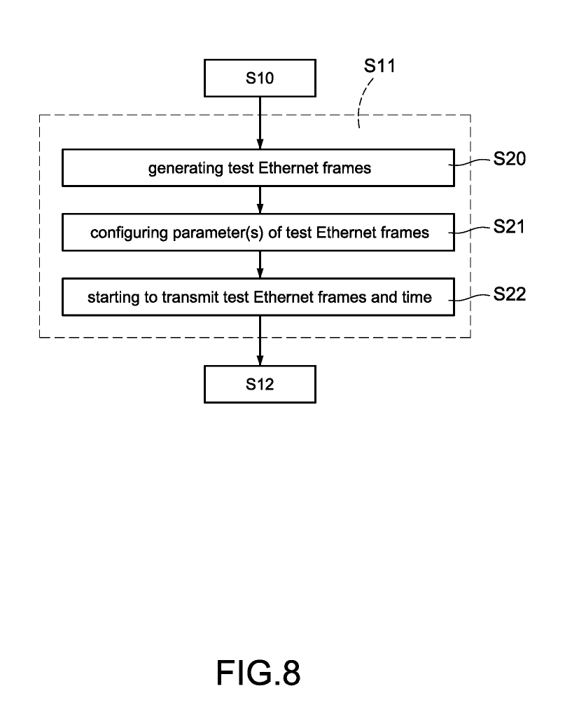

Please refer to FIG. 7 and FIG. 8 simultaneously, FIG. 8 is a partial flowchart of a self-testing method according to the second embodiment of the present disclosed example. Compare to the self-testing method shown in FIG. 7, the step S11 of the self-testing method shown in FIG. 8 11 comprises following steps.

Step S20: the processor 20 enables the first frame-generating module of the first network interface 21 via transmission control module 61 for generating a plurality of test Ethernet frames.

Step S21: the processor 20 configures one or more parameter(s) of each of the test Ethernet frames (such as a source address, a target address and/or a data length of each of the test Ethernet frames) via the enabled first frame-generating module.

One of the exemplary embodiments, the first frame-generating module may configure the source address and/or the target address of each of the test Ethernet frames as fixed address (such as configuring the source address a 00:00:00:00:00:00, and configuring the target address as FF:FF:FF:FF:FF:FF), and configure the data length of each of the test Ethernet frames as maximum (such as 1518 bytes).

Please be noted that above-mentioned embodiment is mainly to configure the data length of each of the test Ethernet frames as maximum for generating large amount of data quickly, so as to make the amount of data generated per unit time (such as 1 second) be not slower than the amount of transportable data per unit time of the high-speed Ethernet. Thus, above-mentioned embodiment can prevent the test from fail caused by the speed of generating the data being slower than the transmission speed.

Besides, the transmission and arrival of any test Ethernet frame does not be affect even the source address and/or the target address of the test Ethernet frame exists fault because there is a one to one connection between the first network cable 21 and the second network interface 22 via the network cable 25 (in other words, the network cable does not connect the other network interface). Thus, the present disclosed example can quickly complete the configuration of large amount of the test Ethernet frames effectively via configuring the source address and the target address of each of the test Ethernet frames as the fixed address.

Step S22: the processor 20 configures the first network interface 21 to start to transmit the test Ethernet frames and start to time the default time interval via the transmission control module 61.

One of the exemplary embodiments, the processor 20 enables the first transmission register to start to transmit the configured test Ethernet frames via the transmission control module 61, and start to time the default time interval via the timing module 60 simultaneously.

Thus, the present disclosed example can quickly generate large amount of test Ethernet frames, quickly configure the large amount of test Ethernet frames, and transmit large amount of test Ethernet frames to outside, so as to be applicable to the transmission speed test for high-Speed Ethernet.

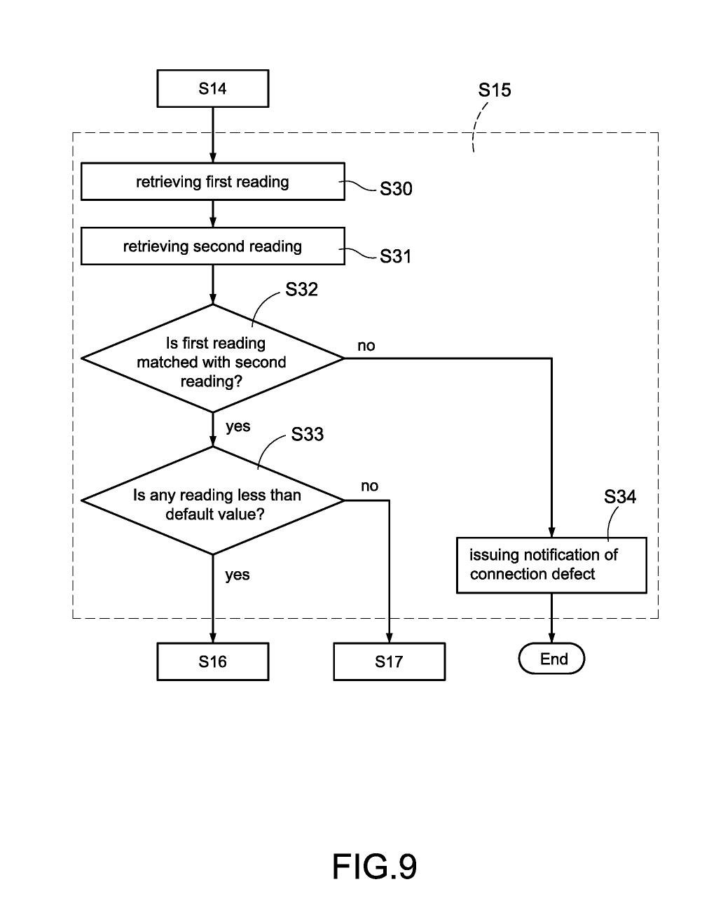

Please refer to FIG. 7 and FIG. 9 simultaneously; FIG. 9 is a partial flowchart of a self-testing method according to the second embodiment of the present disclosed example. Compare to the self-testing method as shown in FIG. 7, the step S15 of the self-testing method as shown in FIG. 9 comprises following steps.

Step S30: the processor 20 retrieves the first reading which is the number of the test Ethernet frames transmitted by the first network interface 21 from the first count register via the count control module 62.

Step S31: the processor 20 retrieves the second reading which is the number of the test Ethernet frames received by the second network interface 22 from the second count register via the count control module 62.

Step S32: the processor 20 determines whether the first reading is matched with the second reading via the connection-checking module 64.

If the processor 20 determines that the first reading is matched with the second reading, the processor 20 performs a step S33. Otherwise, the processor determines that the network cable 25 may exist a defect, and performs as step S34.

Step S33: the processor 20 determines whether the first reading and the second reading are less than a default value (speed default value).

If both the first reading and the second reading are less than the default value, the processor 20 determines that the transmission speed of the first network interface 21 and the second network interface 22, and performs the step S16. If any of the first reading and the second reading is less than the default value, the processor 20 determines that the transmission speed of the first network interface 21 or the second network interface 22 fails in the test, and performs the step S17.

If the processor 20 determines that the network cable 25 probably exist any defect in the step S32, performs a step S34: the processor 20 controlling the human-machine interface 24 to issue a notification of connection defect via the notification module 63 for indicating the test that there is a defect existing in the network cable 25, the first network interface 21 or the second network interface 22.

Above-mentioned notification of connection defect may be text message, voice message, indicator light message, or the other types of messages, but this specific example is not intended to limit the scope of the present disclosed example.

Please be noted that the first reading is matched with the second reading if the network cable 25 supports the high-speed Ethernet transmission and does not any defect. In other words, the number of the test Ethernet frames received by the second network interface 22 is matched with the number of the test Ethernet frames transmitted by the first network interface 21.

Thus, the present disclosed example can determine whether there is any defect (such as do not supply the high-speed Ethernet transmission or damage) existing in the first network interface 21, the second network interface 22 or the network cable 25 effectively.

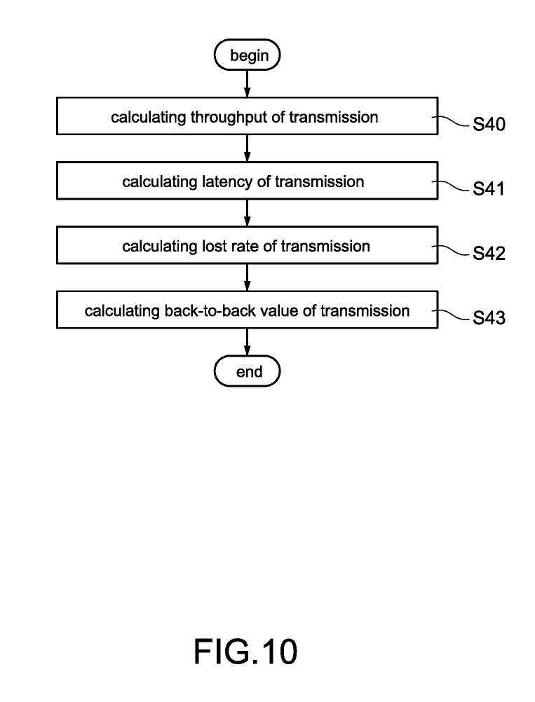

Please refer to FIG. 7 and FIG. 10 simultaneously; FIG. 10 is a partial flowchart of a self-testing method according to the fourth embodiment of the present disclosed example. Compare to the self-testing method as shown in FIG. 7, the self-testing method of this embodiment may further test the other terms of performance of the first network interface 21 and the second network interface 22, such as throughput, latency, lost rate of Ethernet frames or back-to-back value (buffering ability).

More specifically the self-testing method of this embodiment comprises following steps after the step S16 or step S17.

Step S40: the processor 20 calculates throughput of transmission via throughput-calculating module 65, and controls the human-machine interface 24 to display the calculated throughput of transmission via the notification module 63.

One of the exemplary embodiments, the processor 20 adds up the data length of each of the test Ethernet frames transmitted during the default time interval for getting a total data length, and make the total data length divide by the default time interval for getting the throughput of transmission.

Step S41: the processor 20 calculates a latency of transmission via the latency-calculating module 66, and controls the human-machine interface 24 to display the calculated latency of transmission via the notification module 63.

One of the exemplary embodiments, the processor 20 may retrieve at least one transmission time of at least one test Ethernet frame transmitted by the first network interface 21 and at least one reception time of at least one test Ethernet frame received by the second network interface 22. Then, the processor 20 calculates the latency of this transmission according to the retrieved transmission-time and receive-time.

One of the exemplary embodiments, the processor 20 first calculates the latency of transmission of each of the test Ethernet frames according to the transmission time and receive time of each of the test Ethernet frames, and then calculates the latency of transmission of this transmission according to the latencies of transmission of the test Ethernet frames (such as average calculation).

Step S42: the processor 20 calculates a lost rate of transmission via the lost-rate-calculating module 67 according to the number of the test Ethernet frames had been transmitted and a default number, and controls the human-machine interface 24 to display the calculated lost rate of transmission via the notification module 63.

One of the exemplary embodiments, the processor 20 retrieves the default number transmitted expectantly from the frame-generating module 53, and retrieves the second reading from the second count register as the number of the test Ethernet frames received actually. Then, the processor 20 calculates a difference (the number of test Ethernet frames failed in transmission) between the default number and the number of the test Ethernet frames received actually, and calculates a ratio of the difference to the default value as the lost rate of transmission.

Step S43: the processor 20 calculates a back-to-back value of transmission via the back-to-back-calculating module 68, and controls the human-machine interface 24 to display the calculated back-to-back value via the notification module 63.

One of the exemplary embodiments, the processor 20 controls the first network interface 21 to transmit the test Ethernet frames to the second network interface 22 with the maximum transmission speed 25 again via the network cable 25. Moreover, the processor 20 controls the first network interface 21 to change the number of the test Ethernet frames simultaneously transmitted or the data length of each of test Ethernet frames during transmission. In other words, the processor 20 changes the continuous data length of the test Ethernet frames simultaneously transmitted. After completion of transmission, the processor 20 retrieves the maximum continuous data length (the test Ethernet frames corresponding to the maximum continuous data length had been transmitted successfully and simultaneously), and makes the maximum continuous data length as the back-to-back value of transmission of the first network interface 21 and the second network interface 22.

The present disclosed example can test the throughput of transmission, the latency of transmission, the lost rate of transmission, and the back-to-back value of transmission of the high-speed network apparatus effectively.

The above-mentioned are only preferred specific examples in the present disclosed example, and are not thence restrictive to the scope of claims of the present disclosed example. Therefore, those who apply equivalent changes incorporating contents from the present disclosed example are included in the scope of this application, as stated herein.

What is claimed is:

1. A self-testing method for testing transmission performance of a high-speed network apparatus comprising a first network interface and a second network interface, comprising following steps of:
a) configuring the first network interface to start to transmit a plurality of test Ethernet frames to the second network interface via a network cable;
b) count a number of the test Ethernet frames had been transmitted;
c) configuring the first network interface to stop transmitting the test Ethernet frames if a default time interval elapses;
d) issuing a notification of pass in speed test if the number of the test Ethernet frames had been transmitted is not less than a default value; and
e) issuing a notification of fail in speed test if the number of the test Ethernet frames had been transmitted is less than the default value.

2. The self-testing method according to claim 1, wherein the step a) is configured to comprise following steps of:
a1) generating the test Ethernet frames;
a2) configuring a source address, a target address and a data length of each of the test Ethernet frames; and
a3) configuring the first network interface to start to transmit the test Ethernet frames and start to time the default time interval.

3. The self-testing method according to claim 2, wherein the step a1) is configured to enable a first frame-generating module of the first network interface for generating the test Ethernet frames.

4. The self-testing method according to claim 2, wherein the step a2) is configured to configure the source address of each of the test Ethernet frames as 00:00:00:00:00:00, configure the target address of each of the test Ethernet frames as FF:FF:FF:FF:FF:FF, or configure the data length of each of the test Ethernet frames as 1518 bytes.

5. The self-testing method according to claim 1, wherein the first network interface comprises a first transmission register, the step a) is configured to enable the first transmission register for starting to transmit the test Ethernet frames, the step c) is configured to disable the first transmission register for stopping transmitting the test Ethernet frames.

6. The self-testing method according to claim 1, wherein the second network interface comprises a second count register, the step b) is configured to count the number of the test Ethernet frames had been received by the second network interface via the second count register.

7. The self-testing method according to claim 6, wherein the first network interface comprises a first count register, the step b) is configured to count the number of the test Ethernet frames had been transmitted from the first network interface via the first count register.

8. The self-testing method according to claim 7, wherein the step d) is configured to issue the notification of pass in speed test if a second reading of the second count register is matched with a first reading of the first count register and the second reading is not less than the default value; the step e) is configured to issue the notification of fail in speed test if the second reading or the first reading is less than the default value.

9. The self-testing method according to claim 8, further comprising a step f) issuing a notification of connection defect if the second reading is not matched with the first reading.

10. The self-testing method according to claim 1, further comprising following steps of:
g1) calculating a throughput of transmission according to the default time interval and a total data length of the test Ethernet frames had been transmitted;
g2) calculating a latency of transmission according to a transmission time and a receive time of at least one of the test Ethernet frames had been transmitted;
g3) calculating a lost rate of transmission according to the number of the test Ethernet frames had been transmitted and a default number; and
g4) calculating a back-to-back value of transmission according to a continuous data length of the test Ethernet frames being transmitted simultaneously.

11. A high-speed network apparatus having ability of testing transmission performance itself, comprising:
a first network interface connected to one end of a network cable, the first network interface being configured to transmit a plurality of test Ethernet frames to the network cable;
a second network interface connected to another end of the network cable, the second network interface being configured to receive the test Ethernet frames from the network cable;
a human-machine interface configured to issue notification
a processor electrically connected to the first network interface, the second network interface and the human-machine interface, the processor comprising:
a timing module is configured to start to time a default time interval after the first network interface starts to transmit the test Ethernet frames;
a transmission control module configured to configure the first network interface to start to transmit the test Ethernet frames, and configure the first network interface to stop transmitting the test Ethernet frames after the default time interval elapses;
a count control module configured to retrieve a number test Ethernet frames had been transmitted; and
a notification module configured to control the human-machine interface to issue a notification of pass in speed test if the number of the test Ethernet frames had been transmitted is not less than a default value, and issue a notification of fail in speed test if the number of the test Ethernet frames had been transmitted is less than the default value.

12. The high-speed network apparatus according to claim 11, wherein the first network interface comprises a first frame-generating module, the first frame-generating module
is configured to generate the test Ethernet frames and configure a source address, a target address and a data length of each of the test Ethernet frames.

13. The high-speed network apparatus according to claim 12, wherein the first frame-generating module is configured to configure the source address of each of the test Ethernet frames as 00:00:00:00:00:00, configure the target address of each of the test Ethernet frames as FF:FF:FF:FF:FF:FF, or configure the data length of each of the test Ethernet frames as 1518 bytes.

14. The high-speed network apparatus according to claim 11, wherein the first network interface comprises a transmission register, the transmission control module controls the first network interface to start to transmit the test Ethernet frames via enabling the first transmission register, and stop transmitting the test Ethernet frames via disabling the first transmission register.

15. The high-speed network apparatus according to claim 11, wherein the second network interface comprises a second count register, the second count register is configured to count a number of the test Ethernet frames had been received by the second network interface and generate a second reading.

16. The high-speed network apparatus according to claim 15, wherein the first network interface comprises a first count register, the first count register is configured to count a number of the test Ethernet frames had been transmitted from the first network interface, the count control module retrieves a first reading of the first count register and a second reading of the second count register, and determines a number of the test Ethernet frames according to the first reading or the second reading.

17. The high-speed network apparatus according to claim 16, wherein the processor further comprises a connection-checking module, the connection-checking module is configured to issue a notification of connection defect if the first reading is not matched with the second reading.

18. The high-speed network apparatus according to claim 11, wherein the processor further comprises:
a throughput-calculating module configured to calculate a throughput of transmission according to the default time interval and a total data length of the test Ethernet frames had been transmitted;
a latency-calculating module configured to calculate a latency of transmission according to a transmission time and a receive time of at least one of the test Ethernet frames had been transmitted;
a lost-rate-calculating module configured to calculate a lost rate of transmission according to the number of the test Ethernet frames had been transmitted and a default number; and
a back-to-back-calculating module configured to calculate a back-to-back value of transmission according to a continuous data length of the test Ethernet frames being transmitted simultaneously.
